(19) United States
(12) Patent Application Publication
(10) Pub. No.: US 2012/0258709 A1
(43) Pub. Date: Oct. 11, 2012

(54) WORLD MODE SCANNING CONTROL

(75) Inventors: Arvind Swaminathan, San Diego, CA (US); Francis Ming-Meng Ngai, San Diego, CA (US); Ameya Rajendraprasad Kasbekar, San Diego, CA (US)

(73) Assignee: QUALCOMM INCORPORATED, San Diego, CA (US)

(21) Appl. No.: 13/082,926

(22) Filed: Apr. 8, 2011

(51) Int. Cl. H04W 4/02

(52) U.S. Cl. 455/433

(57) ABSTRACT

A method and apparatus for world-mode devices capable of managing technology selection for multimode roaming between existing access technologies, as well as possible future access technologies, in a manner that eliminates wasteful scanning for non-existent systems and reduces roaming charges is disclosed. The method allows the device an opportunity to reacquire its home system before scanning for available roaming network resources in a prioritized manner that mitigates roaming costs, while conserving power and acquisition delays by eliminating scanning for non-existent system types. A minimum OOS duration is imposed on a home system before acquisition of a roaming partner to provide more time to re-acquire the home system. Preferred partner scanning and acquisition reduces roaming charges, while scanning for non existent systems is eliminated altogether.

### BACKGROUND

1. Field

The present invention relates generally to wireless communications, and more specifically to techniques for optimizing the selection of wireless communications systems.

2. Background

With the deployment of a multitude of wireless technologies worldwide and support for these technologies in mobile multimode devices or entities, there is a growing need for seamless system selection toward the goal of global roaming. Furthermore, any particular geographic region may support mixed technologies and networks, such as 3rd Generation Partnership Project (3GPP) and 3rd Generation Partnership Project 2 (3GPP2) networks having WCDMA (Wideband Code Division Multiple Access) air interfaces, Global System for Mobile Communications (GSM), or other network technologies such as Universal Mobile Telecommunication System (UMTS) Terrestrial Radio Access (UTRA). World-mode user equipment (UE) devices support Single carrier (1×) radio transmission technology, CDMA2000 EVDO, CDMA2000 1×RTT, GSM and WCDMA.

A mobile multimode device that supports mixed technologies may include multiple databases that are used in selecting optimal networks within a technology. As an example, for 3GPP2 technologies, such as certain Code Division Multiple Access 2000 (cdma2000 or C2K) networks, a Preferred Roaming List (PRL) database which is stored at the User Equipment (UE) provides information about which system/network is preferred in a geographic region for that device. Whether predetermined or programmed via Over-The-Air (OTA) management protocols, the PRL contains information about the preferred networks and the order in which they should be selected for the user. PRLs for 3GPP2 technologies may be structured to have a table associated with each geographical region, which in turn contains a list of system descriptions keyed by System Identifier/Network Identifier (SID/NID) pairs and associated with an acquisition index. The acquisition index may be used as a pointer to an acquisition table which contains an indexed list of RF channels for channel acquisition purposes in the related system.

For 3GPP technologies, such as Global System for Mobile (GSM) and Universal Mobile Telecommunication System (UMTS) Terrestrial Radio Access (UTRA), a differently structured database list of preferred networks, termed Public Land Mobile Networks (PLMNs), is stored in a Subscriber Identity Module (SIM) or Universal Subscriber Identity Module (USIM) of the mobile device. The PLMNs in the database include a Mobile Network Code (MNC) that is used in combination with a Mobile Country Code (MCC) (also known as a “MCC/MNC tuple”) to uniquely identify a service operator using a 3GPP technology, such as GSM and UMTS public land mobile networks. Identification of a service operator may begin with the 3GPP approach to system selection based on PLMN lists, which may include 3GPP2 access technology identifiers (ATI), also known as Radio Access Technologies (RATs). A PLMN may identify and may be a concatenation of a MCC and a MNC.

When roaming through geographical locations, it is desirable that a multimode device seamlessly select the best available system, particularly when roaming across areas with different available access technologies (e.g., 3GPP and 3GPP2). When a world-mode device goes Out Of Service (OOS) due to loss of signal, current implementations calls for the device to scan 1×, DO, GSM and WCDMA. However, when a 1× carrier does not have roaming agreements with GSM/WCMDA carriers in the vicinity of the home country or the these networks do not exist in the home country, such as Verizon Wireless in the US, scanning GSM/WCDMA while in the home country is a waste of processing resources and power, and it delays the acquisition of service during power-up and the re-acquisition of service during OOS. Furthermore, during OOS, roaming charges paid by subscribers and carriers are accrued as soon as another non-home network is acquired even though the home network OOS may be transitory and the home network could be re-acquired after a short period of time at no cost. Typically the roaming partner is mostly determined by the position of roaming system in GEO/PRL rather than by the fee structure agreements with the most advantageous roaming partners.

There is therefore a need in the art for world-mode devices to manage technology selection for multimode roaming between existing access technologies, as well as possible future access technologies, in a manner that eliminates wasteful scanning for non-existent systems and reduces roaming charges.

### BRIEF DESCRIPTION OF THE DRAWINGS

FIG. 1 is a diagram illustrating an example of a broadcast network in which World Mode Scanning Control can be used;

FIG. 2 is an exemplary flowchart illustrating World Mode Scanning Control; and

FIG. 3 is a block diagram illustrating an exemplary wireless device capable of World Mode Scanning Control.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The terms “mobile device”, “wireless device” and “user equipment” (UE) as used herein refers to a wireless communication device such as a cellular telephone, wireless terminal, user equipment, laptop computer, High Data Rate (HDR) subscriber station, access terminal, or other personal communication system (PCS) device. The device may be either mobile or stationary.

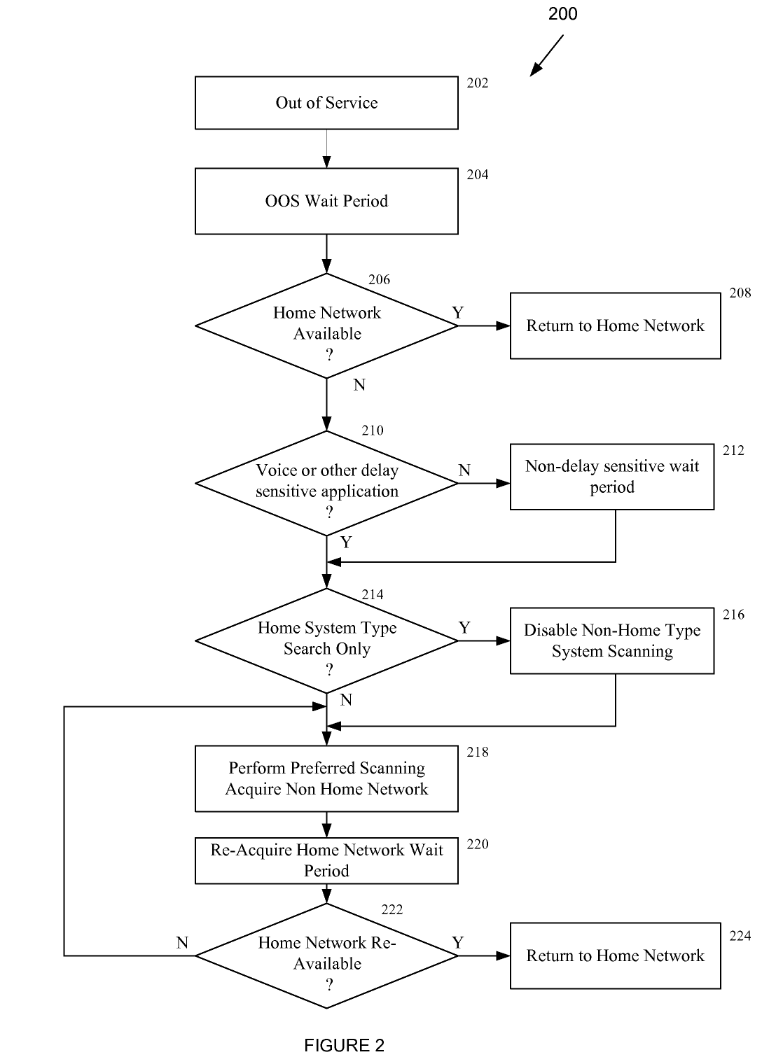

An algorithm to proactively scan for available network resources in a manner that reduces power consumption and mitigates roaming costs is disclosed. The algorithm provides a non-existent network flag, preferred partner scanning, and home network re-acquisition wait periods detailed in FIG. 2.

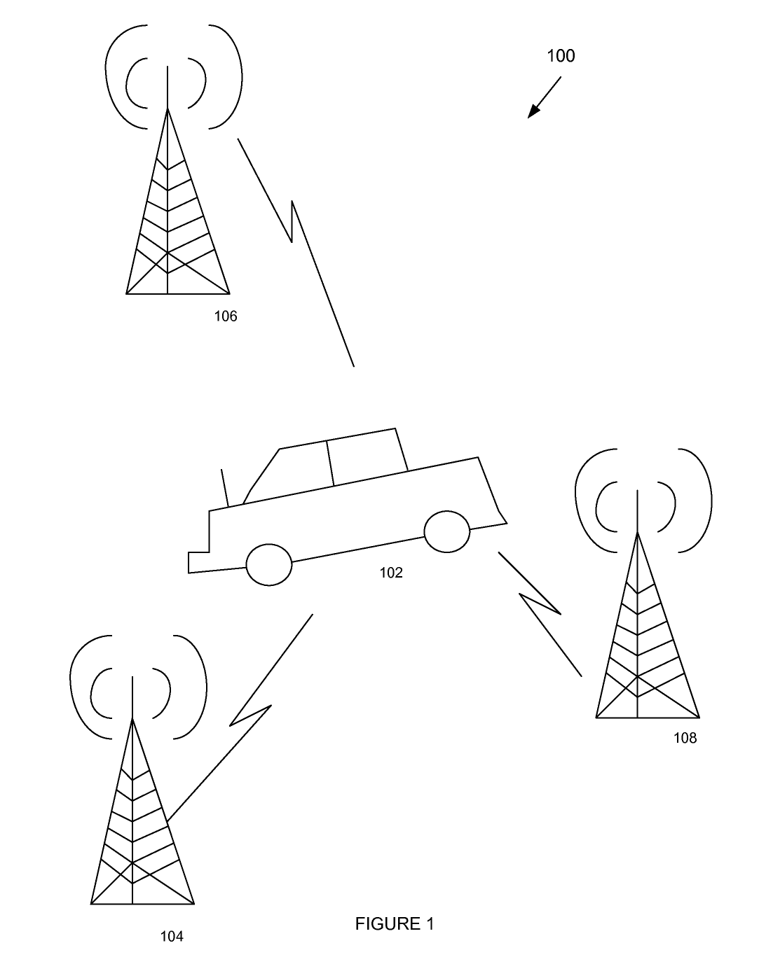

FIG. 1 is a diagram illustrating an example of a wireless communications network in which single path detection and equalizer optimization can be used. As seen in FIG. 1, wireless communications network 100 includes multiple base stations 104, 106 and 108 for transmitting wireless communications signals. Signals and data can be broadcast by base stations 104, 106 and 108 to supply user content and information. For example, streaming video, games or data for other applications may be delivered over the wireless network A receiver User Equipment (UE) 102 receives the data for consumption by the user. In this example, the receiver 102 is depicted as hosted by a car. However, receiving station 102 should not be limited as such, and can also represent, for example, a person, another mobile entity/device, or a stationary entity/device. Furthermore, the receiver can represent a computer, a laptop computer, a telephone, a mobile telephone, a personal digital assistant (PDA), an audio player, a game console, a camera, a camcorder, an audio device, a video device, a multimedia device, a component(s) of any of the foregoing (such as a printed circuit board(s), an integrated circuit(s), and/or a circuit component(s)), or any other device capable of supporting single path detection and equalizer optimization . A host system can be stationary or mobile, and it can be a digital device.

FIG. 2 illustrates an exemplary overview of World mode scanning control. A minimum OOS duration is imposed on a home system before acquisition of a roaming partner to provide more time to re-acquire the home system. Preferred partner scanning and acquisition reduces roaming charges, while scanning for non existent systems is eliminated altogether.

Control flow begins in step 202 when an OOS condition occurs. An OOS condition may occur when a device goes OOS from a home system, the device went OOS from a roaming system after camping on it, or the device cannot determine if the user is in the home country or not, and the device went OOS from a GSM/WCDMA system.

Control flow proceeds to step 204 where an OOS wait period is imposed before a roaming partner can be acquired or the home system can be re-acquired. This time period is fixed, or dynamically configurable to provide more time/opportunities to re-acquire a home system before camping on a roaming system. In one exemplary embodiment, the time period is configurable by phone operators and can be adjusted in response to increases or decreases in accrued roaming charges by a carrier. In another exemplary embodiment, the operator may tune the time period parameter based on user's home location. If the user is in area where network coverage is known to be inconsistent or very reliable, the timer can be adjusted according to network coverage quality.

After completion of the OOS wait period, the home network is scanned for re-availability in step 206. If the OOS was a transient condition and the home system is available, the user is returned to the home system in step 208. Other wise, Control flow proceeds to step 210.

In step 210, if no delay sensitive applications are in use, control flow proceeds to step 212 where a non-delay sensitive wait period is implemented and control flow proceeds to step 214. Otherwise control flow proceeds directly to step 214. For example, if a voice call is being made by the user, no wait period is imposed and roaming charges will incurred from the most advantageous roaming partner available. However if an email or other data application is in the process of sending or receiving data, the non-delay sensitive wait will be imposed in order to delay immediately incurring roaming charges.

In step 214, a home flag is tested to determine whether to skip scanning for non-existent systems. If the home flag indicates non-home system types are not existent in the geographical location of the user, non-home system type scanning is disabled in step 216 and control flow proceeds to step 218. Otherwise control flow proceeds directly to step 218. For example, CDMA networks and devices that allow global roaming include WCDMA and/or GSM capability in UEs. In the US, this capability is inutile, and therefore a waste of processing and power resources to search for WCDMA or GSM networks when the user is located in the US. If a user located in the US enters a tunnel or coverage is lost for some other reason and the home flag indicates non-home system types are non-existent, no scanning will be performed for WCDMA or GSM system types. A world-mode device going 00S from a home system will thus consume less power to reacquire service and provide faster re-acquisition time. When the home carriers strike roaming agreements with GSM/WCDMA carriers in the vicinity of a home country in the future, the carrier can enable non-home system type scanning via OTA service programming

In step 218, scanning for preferred partner systems is performed according to a list of preferred roaming partners that is prioritized by the home system and may be dictated by the terms of partner roaming agreements. The home network has priority number one because the operator wants to direct the user to go there if it is available. The second priority is the least expensive roaming partner and so on to create a list of available systems. Identification of less desirable partners is stored for future reference. If non-home system type scanning was disabled in step 216, non-home system types will not be entered in the list.

If the device has acquired a roaming system that is more preferred than a previously acquired roaming system, the previously acquired system or systems that are less preferred than the newly acquired roaming system, may be deleted from the scanning list. In this manner, the scanning list may be dynamically adjusted.

After the list of available systems has been created in order of roaming agreement preference, an available roaming partner is acquired in accordance with the list and control flow proceeds to 220 where systems more preferred than the acquired system including the home system will be periodically checked for availability so that the UE does not camp on a roaming partner any longer than necessary. Note that roaming systems that are less preferred than the currently acquired roaming system may be removed from the list.

In one embodiment, the term “home system” comprises Verizon's systems in the US.

The term “home country” comprises the United States (U.S.), and includes the Verizon “home system” as well as its roaming partners in the U.S. such as Sprint. “Non-home country systems” in this embodiment may comprise GSM and WCDMA carriers in Europe, Asia, India and/or other continents. Other embodiments may comprise various home systems and home countries without departing from the scope of the invention.

In step 220, a Re-Acquire Home/More Preferred Network wait period is imposed before scanning for availability of the home network. Control proceeds to step 222 where scanning for the home network is performed. If the home network is become available, control flow proceeds to step 224 where the user is returned to its home system. If the home network remains unavailable, control flow returns to step 218 to repeat the process of scanning for availability of a more desirable roaming partner than the current roaming partner and waiting to check for availability of a more preferred network including home network. If the an 00S condition occurs in step 202 during roaming because the current roaming network has been lost, the next most desirable user stored in step 218 will be acquired.

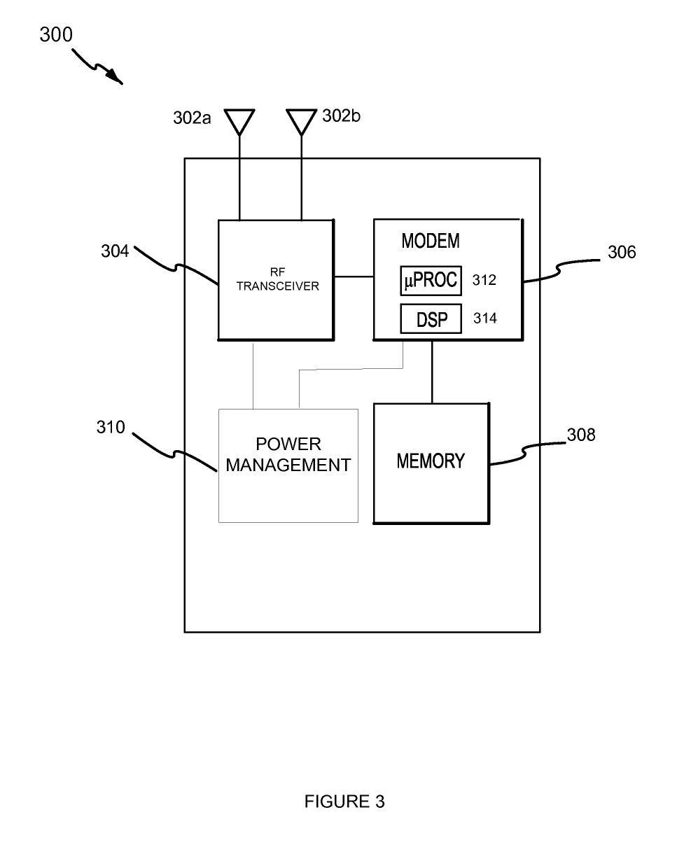

FIG. 3 is a block diagram illustrating an exemplary wireless device capable of World mode scanning control 300. Wireless device 300 comprises a wireless communication transceiver 304 and associated antennas 302a, 302b capable of sending and receiving wireless communication signals. Modem 306 comprises the appropriate microprocessor(s) 312, digital signal processor(s) 314 and other suitable hardware, such as a correlator bank, for processing signals. Power management 310 controls power for various components of wireless device 300. Memory 308 is coupled to modem 304 as necessary for implementing various modem processes and functionality for single path detection and equalizer optimization. Wireless device 300 may comprise an appropriate user interface with alphanumeric keypad, display, microphone, speaker, and other necessary components (not shown). It will be appreciated by those skilled in the art that wireless device 300 may comprise a variety of components not shown.

The methodology for World Mode Scanning Control described herein may be implemented by suitable instructions operating on the microprocessor 312 and memory 308 of wireless device 300, but is certainly not limited to such an implementation and may alternatively be implemented in hardware circuitry. The microprocessor 312 is connected to power management 310 and memory 308 having code or instructions directing the microprocessor 512 to perform World mode scanning control. Memory 308 may comprise instructions for performing World Scanning Control. The memory 308 may include RAM memory, flash memory, ROM memory, EPROM memory, EEPROM memory, registers, a hard disk, a removable disk, a CD-ROM, or any other form of storage medium or computer readable media known in the art. In an exemplary aspect, the control processor 312 executes instructions stored in memory 508 according to the steps of FIG. 2 to perform World mode scanning control.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed:

1. A method for scanning for wireless communication service comprising:
determining that a wireless device has gone Out Of Service;
delaying, for an Out Of Service time interval, re-acquisition of service;
scanning for availability of a home network system after expiration of the interval; and
acquiring service from the home network system if available.

2. The method of claim 1 further delaying, for a Non-Delay Sensitive time period, reacquisition of service when no time sensitive applications are in use.

3. The method of claim 1 where in no scanning is performed for non-home system types when non-home system types are not existent in the geographical location of the user.

4. The method of claim 1 wherein the scanning comprises scanning for preferred partner systems according to a list of preferred roaming partners that is prioritized by the home system according to terms of partner roaming agreements and service is acquired from a system of the highest priority roaming partner available.

5. The method of claim 4 wherein the home network has priority number one, the second priority is the least expensive roaming partner and so on to create a list of available systems.

6. The method of claim 4 wherein periodic re-scanning for the home system is performed after service from a roaming partner has been acquired and the user is returned to the home system if the home system is available.

7. The method of claim 4 wherein service is acquired from a higher priority roaming partner if a service from a higher priority roaming partner becomes available.

8. A wireless receiver comprising:
a wireless communications transceiver and associated antenna(s) capable of sending and receiving wireless communications signals;
a modem coupled to the transceiver comprising processor(s) for processing signals and executing code stored in a memory;
a power management unit coupled to the modem and the transceiver for measuring and controlling transmit power; and
a memory coupled to the modem for storing instructions for delaying, for an Out Of Service time interval, re-acquisition of service, scanning for availability of a home network system after expiration of the interval, and acquiring service from the home network system if available.

9. The wireless receiver of claim 8 further delaying, for a Non-Delay Sensitive time period, reacquisition of service when no time sensitive applications are in use.

10. The wireless receiver of claim 8 wherein in no scanning is performed for non-home system types when non-home system types are not existent in the geographical location of the user.

11. The wireless receiver of claim 8 wherein the scanning comprises scanning for preferred partner systems according to a list of preferred roaming partners that is prioritized by the home system according to terms of partner roaming agreements and service is acquired from a system of the highest priority roaming partner available.

12. The wireless receiver of claim 11 wherein the home network has priority number one, the second priority is the least expensive roaming partner and so on to create a list of available systems.

13. The wireless receiver of claim 11 wherein periodic re-scanning for the home system is performed after service from a roaming partner has been acquired and the user is returned to the home system if the home system is available.

14. The wireless receiver of claim 11 wherein service is acquired from a higher priority roaming partner if a service from a higher priority roaming partner becomes available.

15. A computer readable medium having instructions stored thereon to cause a processor in a wireless device to:
determine that a wireless device has gone Out Of Service;
delay, for an Out Of Service time interval, re-acquisition of service;
scan for availability of a home network system after expiration of the interval; and
acquire service from the home network system if available.

16. The computer readable medium of claim 15 further delaying, for a Non-Delay Sensitive time period, reacquisition of service when no time sensitive applications are in use.

17. The computer readable medium of claim 15 wherein no scanning is performed for non-home system types when non-home system types are not existent in the geographical location of the user.

18. The computer readable medium of claim 15 wherein the scanning comprises scanning for preferred partner systems according to a list of preferred roaming partners that is prioritized by the home system according to terms of partner roaming agreements and service is acquired from a system of the highest priority roaming partner available.

19. The computer readable medium of claim 18 wherein the home network has priority number one, the second priority is the least expensive roaming partner and so on to create a list of available systems.

20. The computer readable medium of claim 18 wherein periodic re-scanning for the home system is performed after service from a roaming partner has been acquired and the user is returned to the home system if the home system is available.

21. The method computer readable medium of claim 18 wherein service is acquired from a higher priority roaming partner if a service from a higher priority roaming partner becomes available.

22. A means for scanning for wireless communication service comprising:
means for determining that a wireless device has gone Out Of Service;
means for delaying, for an Out Of Service time interval, re-acquisition of service;
means for scanning for availability of a home network system after expiration of the interval; and
means for acquiring service from the home network system if available.

23. The means for scanning for wireless communication service of claim 22 further delaying, for a Non-Delay Sensitive time period, reacquisition of service when no time sensitive applications are in use.

24. The means for scanning for wireless communication service of claim 22 where in no scanning is performed for non-home system types when non-home system types are not existent in the geographical location of the user.

25. The means for scanning for wireless communication service of claim 22 wherein the scanning comprises scanning for preferred partner systems according to a list of preferred roaming partners that is prioritized by the home system according to terms of partner roaming agreements and service is acquired from a system of the highest priority roaming partner available.

26. The means for scanning for wireless communication service of claim 25 wherein the home network has priority number one, the second priority is the least expensive roaming partner and so on to create a list of available systems.

27. The means for scanning for wireless communication service of claim 25 wherein periodic re-scanning for the home system is performed after service from a roaming partner has been acquired and the user is returned to the home system if the home system is available.

28. The means for scanning for wireless communication service of claim 25 wherein service is acquired from a higher priority roaming partner if a service from a higher priority roaming partner becomes available.
